(19) United States
(12) Patent Application Publication
(10) Pub. No.: US 2011/0159471 A1
(43) Pub. Date: Jun. 30, 2011

(54) AUDIO/VIDEO TEACHING SYSTEM

(75) Inventor: Cheng-En Su, Taipei (TW)

(73) Assignee: Chunghwa Telecom Co., Ltd., Taipei (TW)

(21) Appl. No.: 12/900,757

(22) Filed: Oct. 8, 2010

(30) Foreign Application Priority Data
Dec. 31, 2009 (TW) 098146232

(51) Int. Cl. G09B 5/00

(52) U.S. Cl. 434/308

(57) ABSTRACT

An audio/video teaching system is connected with learning equipment via a network system to provide for skill evaluation in the learning process. The audio/video teaching system has an audio/video capturing apparatus for capturing audio/video exemplification of various skills and guiding analysis, an audio/video database for storing the audio/video exemplification and guiding analysis, a connection module for connecting with the network system to receive requests and instructions of a user, and a selection module for selecting the required exemplification and guiding analysis from the database, thereby providing a low-cost learning system with ease, convenience and flexibility as compared to prior techniques.

### BACKGROUND OF THE INVENTION

1. Field of the Invention

This invention relates to electronic teaching systems, and more particularly, to an audio/video teaching system using a network system and learning equipment.

2. Description of Related Art

Music is one of the most indispensable elements in human society. Our daily life is full of songs and music. Many people hope to learn correct singing or instrument-playing skills in order to improve their ability.

In general, there are two ways to learn singing or instrument-playing skills: direct learning and indirect learning. As to the direct learning way, a learner (or user) asks for guiding analysis from an experienced instructor in a face-to-face manner to correct shortcomings and add skills. For the indirect learning way, audio/video exemplification made by an instructor is stored in audio/video form into an audio/video storage device such as an optical disk. Accordingly, a user can play the audio/video exemplification at an appropriate learning site and time, using corresponding learning equipment (e.g., a computer).

However, for the direct leaning way, the user has to pay a high tuition fee. Moreover, the learner and the instructor have to agree on the learning site and time. For the indirect learning way, although costing less and allowing a user more flexibility in choosing a learning site and time, it has a serious drawback in that the user cannot get guiding analysis from an instructor, being only able to emulate the recordings and self-evaluate. As such, a user cannot readily find and correct shortcomings effectively.

Therefore, creating a way to provide an audio/video teaching system that works with a network system and learning equipment to allow skill evaluation and that provides ease of use, convenience and flexibility has becoming one of the most urgent needs in the art.

### SUMMARY OF THE INVENTION

In view of the above-mentioned problems of the prior art, the present invention provides an audio/video teaching system connectable via a network system to learning equipment, wherein a user uses the learning equipment to develop skills.

The audio/video teaching system includes: an audio/video capturing apparatus for capturing audio/video exemplification for teaching and guiding analysis corresponding to the audio/video exemplification; an audio/video database for storing the audio/video exemplification and the guiding analysis captured by the audio/video capturing apparatus; a connection module that receive, via the network system, teaching requests and teaching instructions input by the learning equipment; and a selection module that selects corresponding audio/video exemplification and guiding analysis according to the teaching requests and the teaching instructions input via the connection module.

In an embodiment of the present invention, the audio/video teaching system comprises a playing module connected to the selection module for playing corresponding audio/video exemplification and the guiding analysis selected by the selection module.

In another embodiment of the present invention, the audio/video exemplification and the guiding analysis selected by the selection module are transmitted via the connection module and the network system to the learning equipment, for allowing a user to use the learning equipment to play the audio/video exemplification and the guiding analysis.

In conclusion, the audio/video teaching system provided by the present invention allows a user to use the learning equipment and the network system to view the audio/video exemplification and the guiding analysis at an appropriate site and time at will. Therefore, the audio/video teaching system of the present invention has ease of use, convenience and flexibility.

### BRIEF DESCRIPTION OF DRAWINGS

FIG. 1 is a functional block diagram of an audio/video teaching system of a first embodiment according to the present invention; and

FIG. 2 is a functional block diagram of an audio/video teaching system of a second embodiment according to the present invention.

### DETAILED DESCRIPTION OF PREFERRED EMBODIMENTS

The following illustrative embodiments are provided to illustrate the disclosure of the present invention, these and other advantages and effects being readily understood by those in the art after reading the disclosure of this specification. The present invention can also be performed or applied by different embodiments. The details of the specification may be changed in terms of the particulars and applications, and numerous modifications and variations can be devised without departing from the spirit of the present invention.

### First Embodiment

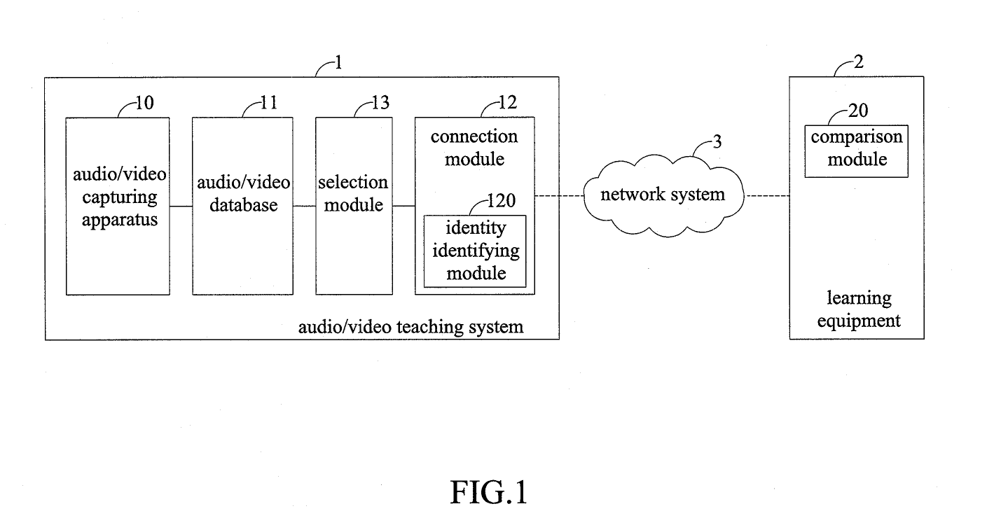

FIG. 1 is a block diagram of an audio/video teaching system 1 of a first embodiment according to the present invention. The audio/video teaching system 1 comprises an audio/video capturing apparatus 10, an audio/video database 11, a connection module 12, and a selection module 13. Accordingly, a user (not shown) can use learning equipment 2 to connect to the audio/video teaching system 1 via a network system 3 that may be a wired network or a wireless network.

The audio/video capturing apparatus 10 captures audio/video exemplification for teaching and also guiding analysis corresponding to the audio/video exemplification. In the first embodiment, the audio/video exemplification refers to digital audio/video files of songs and/or music, and the guiding analysis refers to background stories, key issue reminders, stylistic elements, and/or vocal or playing skills that are produced by an instructor with respect to the aforesaid audio/video exemplification.

For example, the audio/video exemplification includes music video recordings of pop songs and/or exemplary video recordings of well-known music, and the guiding analysis includes teaching films that are produced for the pop songs and/or the well-known music. The content of the teaching films include source data, background stories, key issue reminders, lyrics and musical meanings, emotional analysis, breathing methods and/or vocal skills of pop songs and/or well-known music. The content of the teaching films may further include source data, background stories, key issue reminders, lyrics and music meanings, stylistic elements, emotional analysis and/or skills for using instruments of the well-known music. Note that the aforesaid guiding analysis may be presented in the digital audio/video files in the form of words, sounds and/or images.

The audio/video database 11 is connected to the audio/video capturing apparatus 10, for storing the audio/video exemplification and guiding analysis captured by the audio/video capturing apparatus 10.

The connection module 12 is connected to the network system 3, and receives via the network system 3 teaching requests and teaching instructions input by a user with the learning equipment 2. For example, the learning equipment 2 can be a computer, and the user inputs the teaching requests and teaching instructions with the keyboard and mouse of the computer. In the first embodiment, the connection module 12 further has an identity identifying module 120 that identifies the identity (e.g., account number and password) of a user when the user logs in to the audio/video teaching system 1 with the learning equipment 2.

The selection module 13 is connected to the connection module 12 and the audio/video database 11 for selecting corresponding audio/video exemplification and guiding analysis according to the teaching requests and teaching instructions input by the user via the connection module 12. Preferably, the selection module 13 adopts filtering methods and artificial intelligence algorithms to select the corresponding audio/video exemplification and guiding analysis.

In the first embodiment, the audio/video exemplification and guiding analysis selected by the selection module 13 are transmitted via the connection module 12 and the network system 3 to a storage apparatus of the learning equipment 2. The storage apparatus may include a hard disk or DRAM. Accordingly, the user can use the learning equipment 2 itself or a peripheral multi-media audio/video playing apparatus, such as a screen and speaker, to play the aforesaid audio/video exemplification and guiding analysis. In the first embodiment, the learning equipment 2 further comprises a comparison module 20. The comparison module 20 compares the audio/video exemplification selected by the selection module 13 with practice content made by the user according to the audio/video exemplification, and generates parameterized comparison results.

In practice, the user inputs the title of the song/music that the user desires to learn with the learning equipment 2. The learning equipment 2 may be a computer or a Karaoke system with a network data processing function. The Karaoke system may be embedded with and/or connected to a multi-media audio/video output/input apparatus (not shown), such as a display, speaker and microphone. Accordingly, the selection module 13 selects corresponding music recordings from the audio/video database 11, and transmits the selected music recordings via the connection module 12 to the learning equipment 2. Then, the user may play the music recordings with the learning equipment 2 and input practice content with the microphone or other peripheral apparatus connected to the learning equipment 2. The comparison module 20 compares the pitches and rhythms of the practice content of the user and the music recordings in a real-time manner, and presents parameterized differences in the pitch and rhythm to the user. After the user has become aware of a need for an instructor, the user may input the teaching instructions again, to enable the selection module 13 to select corresponding guiding analysis from the audio/video database 11 and transmit the corresponding guiding analysis to the learning equipment 2 to enable the learning equipment 2 to play the corresponding guiding analysis with a screen and/or speaker. Note that the aforesaid music recordings and guiding analysis may be displayed on the same window frame on the screen.

### Second Embodiment

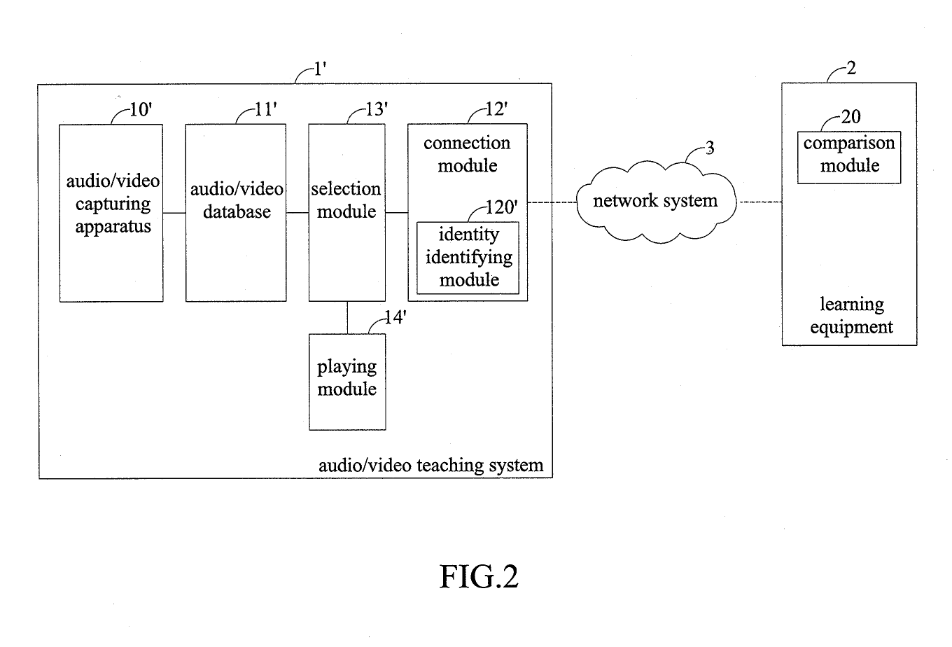

FIG. 2 is an audio/video teaching system 1′ of a second embodiment according to the present invention. The audio/video teaching system 1′ comprises an audio/video capturing apparatus 10′, an audio/video database 11′, a connection module 12′, a selection module 13′ and a playing module 14′.

The second embodiment differs from the first embodiment in that the second embodiment further comprises the playing module 14′, which is connected to the selection module 13′. The playing module 14′ plays audio/video exemplification and guiding analysis selected by the selection module 13′. Therefore, in the second embodiment, the audio/video exemplification and guiding analysis selected by the selection module 13′ need not be transmitted to the learning equipment 2, but can be directly played by the playing module 14′ at the audio/video teaching system 1′ end.

In conclusion, an audio/video teaching system of the present invention comprises an audio/video capturing apparatus for capturing audio/video exemplification and guiding analysis, an audio/video database for storing the audio/video exemplification and the guiding analysis, a connection module for connecting to a network system to receive requests and instructions of a user, and a selection module for selecting corresponding audio/video exemplification and guiding analysis from the audio/video database according to the requests and instructions of the user. Compared with the prior art, the audio/video teaching system of the present invention allows a user to select an appropriate learning site and learning time at will, and has the advantage that the user may learn according to the guiding analysis as if an instructor is teaching interactively teaching in real-time. Therefore, the audio/video teaching system of the present invention is characterized with ease of use, convenience and flexibility as compared with the prior art.

The foregoing descriptions of the detailed embodiments are illustrated to disclose the features and functions of the present invention and are not intended to be restrictive of the scope of the present invention. It should be understood by those in the art that many modifications and variations can be made according to the spirit and principles in the disclosure of the present invention and yet still fall within the scope of the appended claims.

What is claimed is:

1. An audio/video teaching system connectable via a network system to learning equipment, the audio/video teaching system comprising:
an audio/video capturing apparatus for capturing audio/video exemplification for teaching, and guiding analysis corresponding to the audio/video exemplification;
an audio/video database for storing the audio/video exemplification and the guiding analysis captured by the audio/video capturing apparatus;
a connection module that receives via the network system teaching requests and teaching instructions input by the learning equipment; and
a selection module that selects the corresponding audio/video exemplification and guiding analysis from the audio/video database according to the teaching requests and the teaching instructions input via the connection module.

2. The audio/video teaching system of claim 1, further comprising a playing module for playing the audio/video exemplification and the guiding analysis selected by the selection module.

3. The audio/video teaching system of claim 1, wherein the corresponding audio/video exemplification and the guiding analysis selected by the selection module are transmitted by the connection module and the network system to the learning equipment.

4. The audio/video teaching system of claim 3, wherein the learning equipment further comprises a comparison module for comparing the corresponding audio/video exemplification selected by the selection module with practice content made by a user according to the audio/video exemplification, and generating parameterized comparison results.

5. The audio/video teaching system of claim 4, wherein the parameterized comparison results refer to differences in pitch and rhythm.

6. The audio/video teaching system of claim 2, wherein the learning equipment further comprises a comparison module for comparing the corresponding audio/video exemplification selected by the selection module with practice content made by a user according to the audio/video exemplification, and generating parameterized comparison results.

7. The audio/video teaching system of claim 6, wherein the parameterized comparison results refer to differences in pitch and rhythm.

8. The audio/video teaching system of claim 1, wherein the connection module further comprises an identity identifying module for allowing the learning equipment to identify the identity of a user when the user logs in to the audio/video teaching system.

9. The audio/video teaching system of claim 1, wherein the audio/video exemplification includes digital audio/video files of songs and/or music.

10. The audio/video teaching system of claim 1, wherein the guiding analysis refers to background stories, key issue reminders, stylistic elements and/or vocal skills made with respect to the audio/video exemplification.

11. The audio/video teaching system of claim 1, wherein the network system is a wired network or a wireless network.

12. The audio/video teaching system of claim 1, wherein the learning equipment is a computer or a Karaoke system with a network data processing function.
